(19) United States
(12) Patent Application Publication
(10) Pub. No.: US 2026/0031914 A1
(43) Pub. Date: Jan. 29, 2026

(54) LOW-PHASE-NOISE NARROW-LINEWIDTH LIGHT GENERATION APPARATUS AND METHOD BASED ON OPTOELECTRONIC OSCILLATOR

(71) Applicant: INSTITUTE OF SEMICONDUCTORS, CHINESE ACADEMY OF SCIENCES, Beijing (CN)

(72) Inventors: Ming LI, Beijing (CN); Qizhuang CEN, Beijing (CN); Shanhong GUAN, Beijing (CN); Yitang DAI, Beijing (CN)

(73) Assignee: INSTITUTE OF SEMICONDUCTORS, CHINESE ACADEMY OF SCIENCES, Beijing (CN)

(21) Appl. No.: 19/092,797

(22) Filed: Mar. 27, 2025

(30) Foreign Application Priority Data
Jul. 26, 2024 (CN) 202411012237.1

(51) Int. Cl. H04B 10/516; G02F 1/01

(52) U.S. Cl. CPC H04B 10/5161; G02F 1/0121

(57) ABSTRACT

The present disclosure provides a low-phase-noise narrow-linewidth light generation apparatus and method based on an optoelectronic oscillator, which may be applied to a field of optical communication technology. The light generation apparatus includes: a local laser used to output an optical carrier; a phase modulator used to modulate a microwave signal onto the optical carrier, so as to output a phase-modulated optical signal; an optical filter used to filter the phase-modulated optical signal to output desired light and an intensity-modulated optical signal; and a photodetector used to detect the intensity-modulated optical signal to output a radio frequency signal; where the radio frequency signal is modulated onto the optical carrier by the phase modulator, so as to output the phase-modulated optical signal.

### CROSS REFERENCE TO RELATED APPLICATION

This application claims priority to Chinese Patent Application No. 202411012237.1, filed on Jul. 26, 2024, the entire content of which is incorporated herein in its entirety by reference.

### TECHNICAL FIELD

The present disclosure relates to a field of optical communication, in particular to a low-phase-noise, narrow-linewidth light generation apparatus and method based on an optoelectronic oscillator.

### BACKGROUND

Low-noise, narrow-linewidth light source is one of the most important devices in the field of optoelectronics, which is widely used in fields of optical communication, navigation, distance measurement, industrial processing. However, the phase noise and frequency stability of the light source have always been a key factor in restricting its application. High phase noise level will cause signal distortion, and frequency drift will affect the accuracy and stability of the system. In order to solve this problem, researchers have developed various low-phase-noise narrow-linewidth laser generation technologies, which include using optical feedback, optical injection, feedback control, and other methods to suppress the phase noise, as well as using temperature control, current modulation, and other means to achieve high frequency stability. In addition, the application of a new resonant cavity structure such as a microcavity and a fiber ring cavity has also improved the performance of the laser to a certain extent. The development of these technologies has laid the foundation for achieving the light with high stability and high signal-to-noise ratio.

The present disclosure proposes a new low-noise, narrow-linewidth light generation method and apparatus based on an optoelectronic oscillator, which achieves narrower linewidth, lower phase noise, and higher frequency stability through the optoelectronic oscillator technology.

### SUMMARY

The present disclosure provides a low-phase-noise, narrow-linewidth light generation apparatus and method based on an optoelectronic oscillator.

According to a first aspect of the present disclosure, there is provided a low-phase-noise, narrow-linewidth light generation apparatus based on an optoelectronic oscillator, including:
a local laser configured to output an optical carrier for the optoelectronic oscillator;
a phase modulator configured to modulate a microwave signal onto the optical carrier, so as to output a phase-modulated optical signal;
an optical filter including a first port and a second port, where the optical filter is configured to filter the phase-modulated optical signal to output desired light at the first port and output an intensity-modulated optical signal at the second port; and
a photodetector configured to detect the intensity-modulated optical signal to output a radio frequency signal;
where the phase modulator is further configured to modulate the radio frequency signal as the microwave signal onto the optical carrier, so as to output the phase-modulated optical signal.

According to an embodiment of the present disclosure, the light generation apparatus further includes:
a radio frequency power splitter configured to split the radio frequency signal to output at least two radio frequency signals.

According to an embodiment of the present disclosure, the optical filter is any one of a Fabry-Perot cavity, an optical microcavity, an optical micro-disk, an optical microsphere, an optical fiber ring, a grating, and an optical fiber grating, the first port is a transmission port or a drop port, and the second port is a reflection port or a through port.

According to an embodiment of the present disclosure, the light generation apparatus further includes an optical coupler, where the optical coupler is configured to split the optical carrier into two parts, one of which is sent to the phase modulator.

According to an embodiment of the present disclosure, the light generation apparatus further includes a radio frequency power amplifier,
where the radio frequency power amplifier is configured to perform a power amplifying on one of at least two radio frequency signals to output a power-amplified radio frequency signal.

According to an embodiment of the present disclosure, the light generation apparatus further includes an acousto-optic frequency shifter, where the acousto-optic frequency shifter is configured to perform a frequency shifting on the other of two parts of the optical carrier with one of at least two radio frequency signals, so as to output a light with a same center angular frequency as that of the desired light.

According to an embodiment of the present disclosure, the light generation apparatus further includes:
a radio frequency amplifier configured to amplify the radio frequency signal.

A second aspect of the present disclosure provides a light generation method, including:
outputting an optical carrier using a local laser;
modulating a microwave signal onto the optical carrier using a phase modulator, so as to output a phase-modulated optical signal;
filtering the phase-modulated optical signal using an optical filter, so as to output desired light and an intensity-modulated optical signal, where the optical filter includes a first port and a second port, the first port is configured to output the desired light, and the second port is configured to output the intensity-modulated optical signal;
detecting the intensity-modulated optical signal using a photodetector to output a radio frequency signal; and
modulating the radio frequency signal as the microwave signal onto the optical carrier using the phase modulator, so as to output the phase-modulated optical signal.

### BRIEF DESCRIPTION OF THE DRAWINGS

The above content, as well as other objectives, features, and advantages of the present disclosure, will become clearer through the following description of the embodiments of the present disclosure with reference to the accompanying drawings. In the accompanying drawings:

FIG. 1 schematically shows a diagram of a structure of a low-phase-noise, narrow-linewidth light generation apparatus based on an optoelectronic oscillator according to an embodiment of the present disclosure;

FIG. 2A schematically shows the spectrum of a phase-modulated optical signal according to an embodiment of the present disclosure;

FIG. 2B schematically shows the spectrum of the desired light according to an embodiment of the present disclosure;

FIG. 2C schematically shows the spectrum of an intensity-modulated optical signal according to an embodiment of the present disclosure;

FIG. 2D schematically shows the frequency spectrum of a radio frequency signal according to an embodiment of the present disclosure;

FIG. 3 schematically shows a diagram of a structure of another low-phase-noise light generation apparatus based on an optoelectronic oscillator according to an embodiment of the present disclosure;

FIG. 4 schematically shows a diagram of a structure of another low-phase-noise light generation apparatus based on an optoelectronic oscillator according to an embodiment of the present disclosure;

FIG. 5 schematically shows a diagram of a structure of another low-phase-noise light generation apparatus based on an optoelectronic oscillator according to an embodiment of the present disclosure;

FIG. 6 schematically shows a diagram of a comparison of the phase noise of a local laser, the phase noise of the desired light, and a phase noise of a radio frequency signal according to an embodiment of the present disclosure;

FIG. 7 schematically shows a diagram of a comparison of the linewidth of a local laser and the linewidth of the desired light according to an embodiment of the present disclosure; and

FIG. 8 schematically shows a flowchart of a low-phase-noise light generation method based on an optoelectronic oscillator according to an embodiment of the present disclosure.

### DETAILED DESCRIPTION OF EMBODIMENTS

Hereinafter, the embodiments of the present disclosure will be described with reference to the drawings. However, it should be understood that these descriptions are only exemplary, and are not intended to limit the scope of the present disclosure. In the following detailed description, for ease of explanation, many specific details are set forth to provide a comprehensive understanding of the embodiments of the present disclosure. However, obviously, one or more embodiments may also be implemented without these specific details. In addition, in the following description, descriptions of well-known structures and technologies are omitted to avoid unnecessarily obscuring the concept of the present disclosure.

The terms used here are only for describing specific embodiments, and are not intended to limit the present disclosure. The terms “include”, “comprise”, etc. used herein indicate an existence of described characteristics, steps, operations and/or components, but do not exclude a presence or addition of one or more other characteristics, steps, operations or components.

Unless otherwise defined, all terms (including technical and scientific terms) used herein have the meanings commonly understood by those skilled in the art. It should be noted that the terms used here should be interpreted as having meanings consistent with the context of the specification, and should not be interpreted in an idealized or overly rigid manner.

In the case of using an expression similar to “at least one of A, B and C, etc.”, generally speaking, it should be interpreted according to the meaning of the expression commonly understood by those skilled in the art (for example, “a system having at least one of A, B, and C” shall include, but is not limited to, a system having A alone, B alone, C alone, A and B, A and C, B and C, and/or A, B and C, etc.).

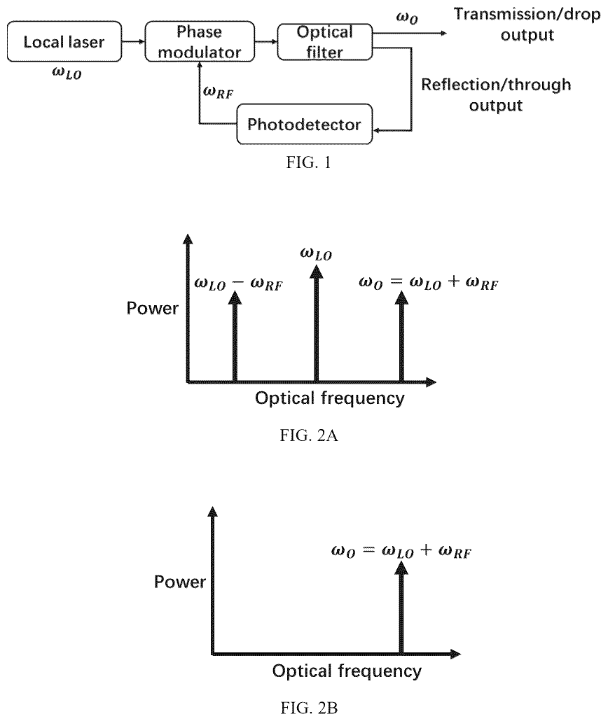

FIG. 1 schematically shows a diagram of a structure of a low-phase-noise light generation apparatus based on an optoelectronic oscillator according to an embodiment of the present disclosure.

As shown in FIG. 1, the low-phase-noise light generation apparatus based on an optoelectronic oscillator in this embodiment includes a local laser, a phase modulator, an optical filter, and a photodetector. The local laser is used to output an optical carrier. The phase modulator is used to modulate a microwave signal onto the optical carrier, so as to output a phase-modulated optical signal. The optical filter includes a first port and a second port, and the optical filter is used to filter the phase-modulated optical signal to output desired light at the first port and output an intensity-modulated optical signal at the second port. The photodetector is used to detect the intensity-modulated optical signal to output a radio frequency signal. The phase modulator is further used to modulate the radio frequency signal as the microwave signal onto the optical carrier, so as to output the phase-modulated optical signal.

According to an embodiment of the present disclosure, the optical filter is any one of a Fabry-Perot cavity, an optical microcavity, an optical micro-disk, an optical microsphere, an optical fiber ring, a grating, and an optical fiber grating. The first port is a transmission port or a drop port (i.e. a transmission/drop port), and the second port is a reflection port or a through port (i.e. a reflection/through port). In a case that the optical filter is a Fabry-Perot cavity or an optical fiber grating, the first port is the transmission port and the second port is the reflection port. In a case that the optical filter is an optical micro-disk, an optical microsphere, or an optical fiber ring, the first port is the drop port and the second port is the through port.

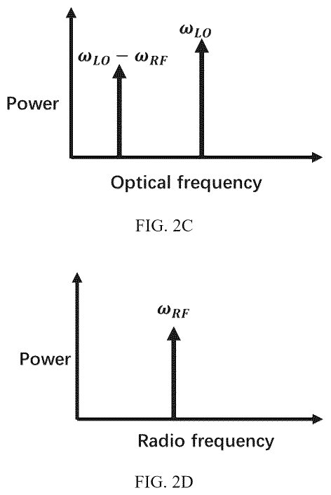

According to an embodiment of the present disclosure, an optoelectronic oscillator based on phase modulation and intensity modulation is constructed. The center angular frequency of the local laser is ω_{LO}, and the center angular frequency of the optical filter is ω_{Filter}. Without the loss of generality, it is assumed that ω_{Filter}>ω_{LO}. When the gain of the optoelectronic link is large enough, a radio frequency signal with an angular frequency of ω_{RF}=ω_{Filter}−ω_{O} will be generated, where ω_{O}≈ω_{Filter} is the angular frequency of the desired light. The radio frequency signal is modulated onto the optical carrier through the phase modulator. The spectrum of the phase-modulated optical signal output by the phase modulator is shown in FIG. 2A. The phase-modulated optical signal is input into the optical filter, and is output through the transmission/drop port and the reflection/through port. The angular frequency of the desired light output through the transmission/drop port is ω_{O}=ω_{LO}±ω_{RF}. The spectrum of the desired light output through the transmission/drop port is shown in FIG. 2B. The angular frequencies of the intensity-modulated optical signal output through the reflection/through port are ω_{LO}−ω_{RF}, ω_{LO}, respectively. The spectrum of the intensity-modulated optical signal output through the reflection/through port is shown in FIG. 2C. The intensity-modulated optical signal output through the reflection/through port is detected by the photodetector to obtain the radio frequency signal with the angular frequency of ω_{RF}. The frequency spectrum of the radio frequency signal output by the photodetector is shown in FIG. 2D.

In some embodiments of the present disclosure, the desired light is the (+1) or (−1) order sideband of the phase-modulated optical signal.

As shown in FIG. 1, the optical filter has a transmission/drop port (i.e. the first port) that filters out one of the sidebands of the phase-modulated optical signal, and the sideband may be (+1) or (−1) order sideband. An angular frequency of this (±1) order sideband is determined by the center frequency of the optical filter, which is ω_{Filter}≈ω_{O}=ω_{LO}+ω_{RF}, that is, the sideband is automatically locked to the center frequency of the optical filter. It is understandable that the optical filter here is implemented as an etalon to determine the stability of desired light output from the transmission/drop port.

In some embodiments of the present disclosure, as shown in FIG. 1, the optical filter also has a reflection/through port (i.e. the second port), whose output is an intensity-modulated optical signal, and its modulation frequency is ω_{RF}. When the frequency of the local laser changes, as long as the center frequency of the optical filter remains unchanged, the oscillation frequency of the optoelectronic oscillator also changes accordingly, while the angular frequency ω_{O} of the desired light output through the transmission/drop port basically remains unchanged. It may be seen that the frequency of the desired light does not vary with the change in the local laser frequency, thus achieving frequency stability. The frequency of the RF signal varies with the frequency of the local laser.

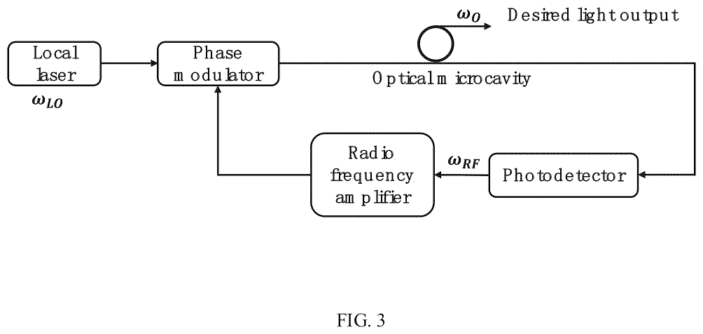

FIG. 3 schematically shows a diagram of a structure of another low-phase-noise light generation apparatus based on an optoelectronic oscillator according to an embodiment of the present disclosure.

As shown in FIG. 3, in addition to the local laser, the phase modulator, the optical filter, the photodetector, and the radio frequency power splitter shown in FIG. 1, the light generation apparatus provided in this embodiment further includes a radio frequency amplifier. The radio frequency amplifier is used to amplify the radio frequency signal. The optical filter is an optical microcavity. A through port of the optical microcavity is used to output the intensity-modulated optical signal. A drop port of the optical microcavity is used to output the desired light.

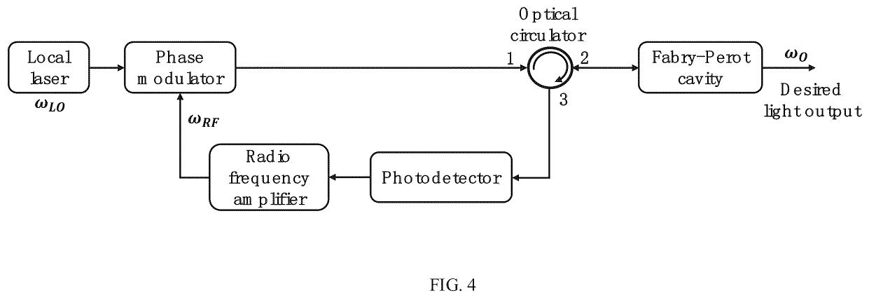

FIG. 4 schematically shows a diagram of a structure of another low-phase-noise light generation apparatus based on an optoelectronic oscillator according to an embodiment of the present disclosure.

As shown in FIG. 4, the light generation apparatus provided in this embodiment includes a local laser, a phase modulator, an optical filter, a photodetector, and a radio frequency amplifier. The optical filter includes an optical circulator and a Fabry-Perot cavity. The optical circulator includes a first port, a second port, and a third port. The phase modulator is connected to the first port 1, the Fabry-Perot cavity is connected to the second port 2, and the photodetector is connected to the third port 3.

According to an embodiment of the present disclosure, the Fabry-Perot cavity combined with the optical circulator is used as the optical filter. The modulated optical signal enters the first port 1 of the optical circulator and is output to the Fabry-Perot cavity through the second port 2. The light reflected by the cavity is output through the third port 3 of the optical circulator. In this structure, the output at the third port 3 of the optical circulator is the intensity-modulated optical signal. The transmission port of the Fabry-Perot cavity is used to output the desired light, and the desired light has characteristics of narrow linewidth and low phase noise.

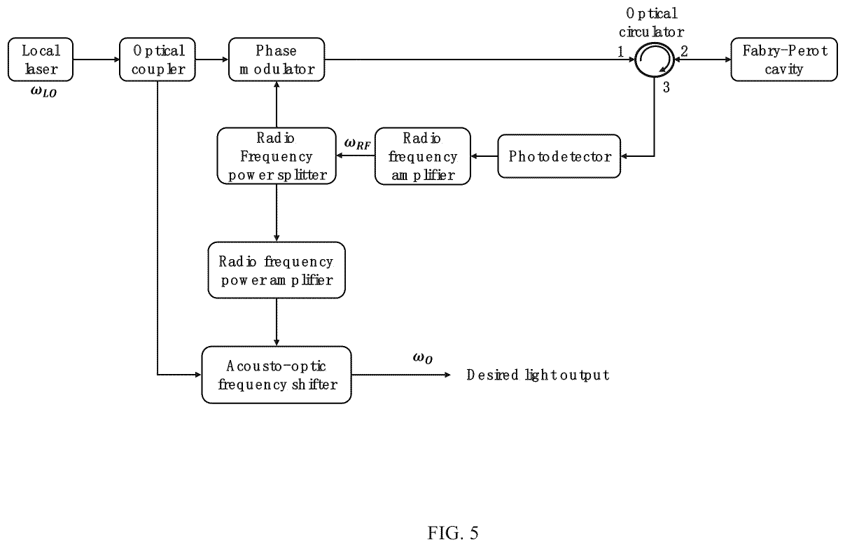

FIG. 5 schematically shows a diagram of a structure of another low-phase-noise light generation apparatus based on an optoelectronic oscillator according to an embodiment of the present disclosure.

As shown in FIG. 5, in addition to the local laser, the phase modulator, the optical filter, the photodetector, the radio frequency amplifier, and the radio frequency power splitter, the light generation apparatus provided in this embodiment further includes an optical coupler, a radio frequency power amplifier, and an acousto-optic frequency shifter. The optical coupler is used to split the optical carrier into two parts, one of which is output to the phase modulator and used as the optical carrier of the optoelectronic oscillator and other is output to the acousto-optic frequency shifter. The radio frequency power amplifier is used to amplify one of at least two radio frequency signals. The acousto-optic frequency shifter is used to perform frequency shifting on the other part of the optical carrier with the power-amplified radio frequency signal, so as to output low-phase-noise, narrow-linewidth light with angular frequency of ω_{O}.

According to an embodiment of the present disclosure, considering that in some systems, such as ultra-stable laser systems, the coupling efficiency of the Fabry-Perot cavity is usually low, an output power of desired light in FIG. 4 may be relatively low. The light generation apparatus provided in FIG. 5 may be used to obtain low-phase-noise light with a relatively high power and stable frequency. The optical carrier is split into two parts by the optical coupler, one of which is input into the optoelectronic cavity as the optical carrier of the optoelectronic oscillator, while the other of which is input to an acousto-optic frequency shifter. The oscillating radio frequency signal in the optoelectronic oscillator is split into two parts, one of which is used to generate a phase-modulated optical signal, while the other of which is amplified by the radio frequency power amplifier to drive the acousto-optic frequency shifter. The phase noise and frequency fluctuations of the local laser is eliminated after frequency shifting, so that the acousto-optic frequency shifter outputs the light with low noise and stable frequency. When ω_{Filter}>ω_{LO}, the angular frequency of light after the acousto-optic frequency shifter is ω_{O}, the same as that of the (+1) order sideband of the phase-modulated optical signal. When ω_{Filter}<ω_{LO}, the angular frequency of light after the acousto-optic frequency shifter is still ω_{O}, the same as that of the (−1) order sideband of the phase-modulated optical signal. That is, the final output of frequency-shifted light is always locked to the center frequency of the optical filter.

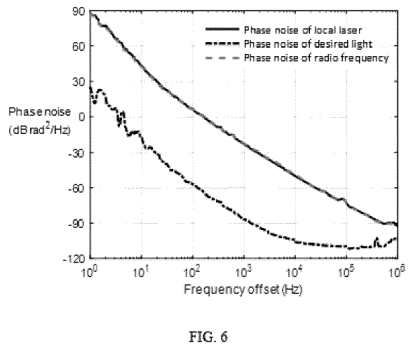

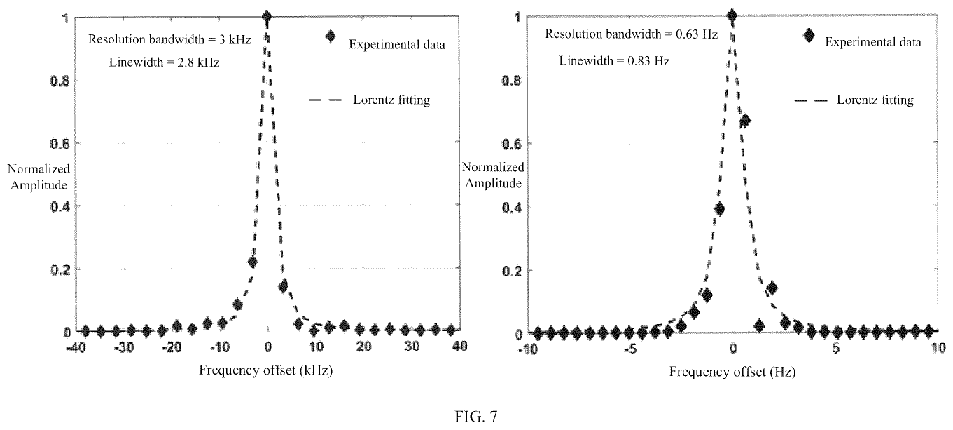

According to an embodiment of the present disclosure, FIG. 6 shows a comparison of the phase noise of a local laser, the phase noise of the desired light, and the phase noise of the radio frequency signal in a low-phase-noise light generation apparatus based on an optoelectronic oscillator provided by this embodiment. It may be seen that the phase noise of desired light has been significantly reduced compared to that of the local laser, achieving noise suppression factor of over 70 dB. The linewidths of the local laser and the desired light are compared in FIG. 7. In FIG. 7, the linewidth of the local laser in the left figure is 2.8 kHz, while the linewidth of the desired light in the right figure is 0.83 Hz, indicating that a low-noise, narrow-linewidth light is generated based on this embodiment.

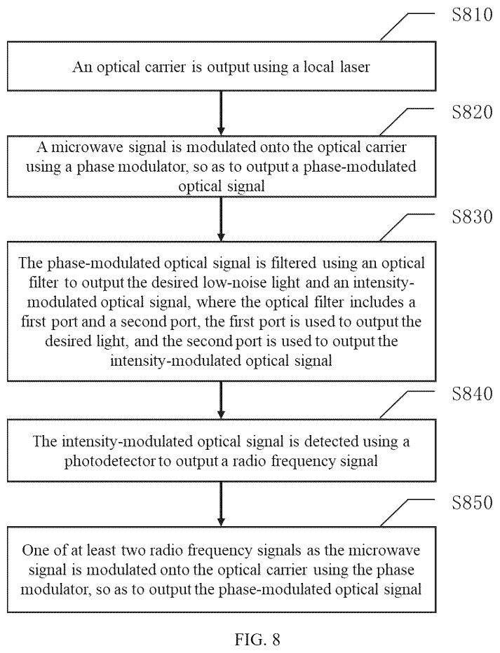

Based on the above light generation apparatus, the present disclosure also provides a low-noise, narrow-linewidth light generation method. The light generation method will be described in detail below with reference to FIG. 8.

FIG. 8 schematically shows a flowchart of a low-phase-noise light generation method according to an embodiment of the present disclosure.

As shown in FIG. 8, the light generation method in this embodiment includes operation S810 to operation S850.

In operation S810, an optical carrier is output using a local laser.

In operation S820, a microwave signal is modulated onto the optical carrier using a phase modulator, so as to output a phase-modulated optical signal.

In operation S830, the phase-modulated optical signal is filtered using an optical filter, so as to output desired light and an intensity-modulated optical signal. The optical filter includes a first port and a second port. The first port is used to output the desired light, and the second port is used to output the intensity-modulated optical signal.

In operation S840, the intensity-modulated optical signal is detected using a photodetector to output a radio frequency signal.

In operation S850, the radio frequency signal as the microwave signal is modulated onto the optical carrier using the phase modulator, so as to output the phase-modulated optical signal.

The delay at the center frequency of the optical filter is set as τ_{O}, the delay of the optoelectronic link excluding the optical filter is set as τ_{RF}, and the phase noise of the local laser is set as S_{LO}(f), and the phase noise of the desired light is set as S_{O}(f). They can be expressed as:

$${S}_{O} ( f ) = {( \frac{{τ}_{RF}}{{τ}_{RF} + {τ}_{O}} )}^{2} {S}_{LO} ( f ) \qquad Equation ( 1 )$$

From Equation (1), it may be seen that the phase noise of the desired light has a fixed relationship with the phase noise of the local laser.

Furthermore, in the embodiments of the present disclosure, by reducing the delay τ_{RF} of the radio frequency signal while increasing the delay τ_{O} of the optical filter (which may be achieved by using a narrower-bandwidth filter), it is possible to make τ_{O}>>τ_{RF}, resulting in

$${( \frac{{τ}_{RF}}{{τ}_{RF} + {τ}_{O}} )}^{2} \approx 0 .$$

That is, the phase noise of the desired light output through the transmission/drop port of the optical filter is almost unaffected by the local laser, so as to obtain low phase noise.

In some embodiments of the present disclosure, the radio frequency signal may be used to drive the acousto-optic frequency shifter to shift the frequency of the local laser, so as to obtain a low-phase-noise light with sufficient power. This light has the same frequency and almost identical phase noise characteristics as the desired light. It may avoid the cases in some systems where, for example, an ultra-narrow-linewidth Fabry-Perot cavity is used as an optical filter, the optical power from the transmission port may be small and difficult to be collected.

The low-phase-noise, narrow-linewidth light generation apparatus and method based on the optoelectronic oscillator provided in the embodiments of the present disclosure have at least the following technical effects:
(1) The present disclosure may not depend on gain in the optical domain, which may effectively avoid the influence of driving circuit, power supply noise, as well as other optical nonlinear effects;
(2) Although the local laser is used, the noise of the local laser is greatly suppressed, so that light with low phase noise and narrow linewidth may be obtained;
(3) The low-phase-noise light generation method provided by the present disclosure may be used in discrete device systems or integrated optoelectronic systems, and may be implemented based on different types of optical filters at different wavelength; and
(4) The process of oscillation by the low-phase-noise, narrow-linewidth light in the present disclosure is a spontaneous process, which does not require precise tuning of the local laser to align the external cavity resonance, as is required in other external cavity laser schemes such as injection locking scheme.

The flowcharts and block diagrams in the accompanying drawings illustrate the possible architectures, functions, and operations implemented by the system and the method according to various embodiments of the present disclosure. In this regard, each box in the flowchart or the block diagram may represent a module, a program segment, or a part of code that contains one or more executable instructions for implementing specified logical functions. It should also be noted that in some alternative implementations, the functions marked in the boxes may be executed in a different order than those marked in the accompanying drawings. For example, two consecutive boxes may actually be executed in parallel, and sometimes they may also be executed in a reverse order, depending on the functions involved. It should also be noted that each box in the block diagram or the flowchart, as well as combinations of boxes in the block diagram or the flowchart, may be implemented using dedicated hardware-based systems that perform specified functions or operations, or may be implemented using a combination of dedicated hardware and computer instructions.

Those skilled in the art may understand that the features described in the various embodiments of the present disclosure and/or the claims may be combined and/or incorporated in various ways, even if such combinations or incorporations are not explicitly described in the present disclosure. In particular, without departing from the spirit and teachings of the present disclosure, the features described in the various embodiments of the present disclosure and/or the claims may be combined and/or incorporated in various ways. All these combinations and/or incorporations fall within the scope of the present disclosure.

The embodiments of the present disclosure have been described above. However, these embodiments are for illustrative purposes only, and are not intended to limit the scope of the present disclosure. Although the respective embodiments are described above, this does not mean that the measures in the respective embodiments may not be advantageously used in combination. The scope of the present disclosure is defined by the appended claims and their equivalents. Those skilled in the art may make various substitutions and modifications without departing from the scope of the present disclosure, and these substitutions and modifications should all fall within the scope of the present disclosure.

What is claimed is:

1. A light generation apparatus based on an optoelectronic oscillator, comprising:
a local laser configured to output an optical carrier;
a phase modulator configured to modulate a microwave signal onto the optical carrier, so as to output a phase-modulated optical signal;
an optical filter comprising a first port and a second port, wherein the optical filter is configured to filter the phase-modulated optical signal to output desired light at the first port and output an intensity-modulated optical signal at the second port; and
a photodetector configured to detect the intensity-modulated optical signal to output a radio frequency signal;
wherein the phase modulator is further configured to modulate the radio frequency signal as the microwave signal onto the optical carrier, so as to output the phase-modulated optical signal.

2. The light generation apparatus according to claim 1, further comprising:
a radio frequency power splitter configured to split the radio frequency signal to output at least two radio frequency signals.

3. The light generation apparatus according to claim 1, wherein the optical filter is any one of a Fabry-Perot cavity, an optical microcavity, an optical micro-disk, an optical microsphere, an optical fiber ring, a grating, and an optical fiber grating,
wherein the first port is a transmission port or a drop port, and the second port is a reflection port or a through port.

4. The light generation apparatus according to claim 1, further comprising:
an optical coupler,
wherein the optical coupler is configured to split the optical carrier into two parts, and one of the two parts is output to the phase modulator.

5. The light generation apparatus according to claim 1, further comprising:
a radio frequency power amplifier,
wherein the radio frequency power amplifier is configured to power amplify one of at least two radio frequency signals to output a power-amplified radio frequency signal.

6. The light generation apparatus according to claim 5, further comprising:
an acousto-optic frequency shifter,
wherein the acousto-optic frequency shifter is configured to perform a frequency shifting on other part of the optical carrier with power-amplified radio frequency signal, so as to output a light with a same center angular frequency as that of the desired light.

7. The light generation apparatus according to claim 1, further comprising:
a radio frequency amplifier configured to amplify the radio frequency signal after the photodetector.

8. A light generation method, comprising:
outputting an optical carrier using a local laser;
modulating a microwave signal onto the optical carrier using a phase modulator, so as to output a phase-modulated optical signal;
filtering the phase-modulated optical signal using an optical filter, so as to output desired light and an intensity-modulated optical signal, wherein the optical filter comprises a first port and a second port, the first port is configured to output the desired light, and the second port is configured to output the intensity-modulated optical signal;
detecting the intensity-modulated optical signal using a photodetector to output a radio frequency signal; and
modulating the radio frequency signal as the microwave signal onto the optical carrier using the phase modulator, so as to output the phase-modulated optical signal.
